(19) United States
(12) Patent Application Publication
(10) Pub. No.: US 2025/0030014 A1
(43) Pub. Date: Jan. 23, 2025

(54) Fuel Cell and Voltage Tapping Device

(71) Applicant: ERNI International AG, Schaffhausen (CH)

(72) Inventors: Stephen Kaminski, Salach (DE); Cornelius Thomas, Bad Boll (DE)

(73) Assignee: ERNI International AG, Schaffhausen (CH)

(21) Appl. No.: 18/905,844

(22) Filed: Oct. 3, 2024

Related U.S. Application Data
(63) Continuation of application No. PCT/EP2023/058799, filed on Apr. 4, 2023.

(30) Foreign Application Priority Data
Apr. 6, 2022 (DE) 10 2022 108 278.4

(51) Int. Cl. H01M 8/0284; H01M 8/0202; H01M 8/0247

(52) U.S. Cl. CPC H01M 8/0284; H01M 8/0247; H01M 8/0269

(57) ABSTRACT

A fuel cell includes a plurality of bipolar plates having a plurality of contacting surfaces and a conductive rubber element having a plurality of electrically conductive regions alternating successively with a plurality of electrically insulating regions. The conductive rubber element is arranged at an angle α to an orthogonal of the contacting surfaces of the bipolar plates, wherein B≥3.5·p·cos(α)−b·sin(α) is satisfied. B is a width of one of the contacting surfaces on one of the bipolar plates, b is a width of the electrically conductive regions and electrically insulating regions of the conductive rubber element, and p is a grid pitch of the conductive rubber element.

### CROSS-REFERENCE TO RELATED APPLICATIONS

This application is a continuation of PCT International Application No. PCT/EP2023/058799, filed on Apr. 4, 2023, which claims priority under 35 U.S.C. § 119 to German Patent Application No. 102022108278.4, filed on Apr. 6, 2022.

### FIELD OF THE INVENTION

The present invention relates to the electrical contacting of a fuel cell with at least one conductive rubber element. Furthermore, the present invention relates to a voltage tapping device for such a fuel cell.

### BACKGROUND OF THE INVENTION

Fuel cells convert chemical energy into electrical energy with a high degree of efficiency. They often consist of packs of individual cells; so-called stacks. The individual cells typically comprise a bipolar flow field plate on each side, between which an electrolyte and a membrane are arranged. The electrical voltage generated by the chemical reaction is conducted across the membrane. This voltage can be measured at the bipolar plates and is a key parameter for operating the fuel cell.

For example, spring contacts mounted on a holder can be used to measure the cell voltages. These contacts are positioned on each individual cell and fixed to a circuit board with a holder or housing. This circuit board has conductor tracks, which transmit the electrical voltage of the individual cells to a measuring device.

German Patent Application DE 10 2007 038 153 A1 describes a fuel cell with a conductive rubber element used to tap the voltage between two bipolar plates. This conductive rubber element comprises alternating electrically conductive and electrically insulating regions. It is arranged at an angle of 90° to the bipolar plates on their surface. The electrically conductive regions of the conductive rubber element provide electrical contact with the bipolar plates. The electrically insulating regions prevent a short circuit between the bipolar plates. In contrast to the use of spring contacts, this type of contact is easier to adjust geometrically. In addition, a contact pairing between rubber and bipolar plate prevents many degradation mechanisms that can occur with individual metal and/or precious metal contact pairings. Furthermore, a conductive rubber element as an electrical contact element is relatively tough against external vibration and shock loads.

However, there are applications in which the area on which the conductive rubber element can contact the bipolar plate is much smaller than described in the above patent specification. For example, it is conceivable to contact a bipolar plate solely via a narrow end face in the edge area of the plate.

### SUMMARY OF THE INVENTION

A fuel cell includes a plurality of bipolar plates having a plurality of contacting surfaces and a conductive rubber element having a plurality of electrically conductive regions alternating successively with a plurality of electrically insulating regions. The conductive rubber element is arranged at an angle α to an orthogonal of the contacting surfaces of the bipolar plates, wherein B≥3.5·p·cos(α)−b·sin(α) is satisfied. B is a width of one of the contacting surfaces on one of the bipolar plates, b is a width of the electrically conductive regions and electrically insulating regions of the conductive rubber element, and p is a grid pitch of the conductive rubber element.

### BRIEF DESCRIPTION OF THE DRAWINGS

Examples of embodiments of the invention are shown in the drawings and are explained in more detail in the following description.

FIG. 1a shows a top view of a fuel cell with a voltage tapping device according to an embodiment;

FIG. 1b shows an isometric view of the fuel cell with the voltage tapping device according to FIG. 1a;

FIG. 1c shows a view of the fuel cell with the voltage tapping device according to FIG. 1a from below;

FIG. 2 shows a section of FIG. 1c, from which a conductive rubber element has been removed as an example;

FIG. 3 shows an underside of a printed circuit board according to an embodiment with an electrical connector on its upper side;

FIG. 4a shows an arrangement of a conductive rubber element relative to two contacting surfaces on bipolar plates in an embodiment in isometric view;

FIG. 4b shows a top view of the conductive rubber element and the two bipolar plates of FIG. 4a; and

FIG. 5 shows distances and angles on the conductive rubber element and the contacting surfaces on the bipolar plates according to FIG. 4b.

### DETAILED DESCRIPTION

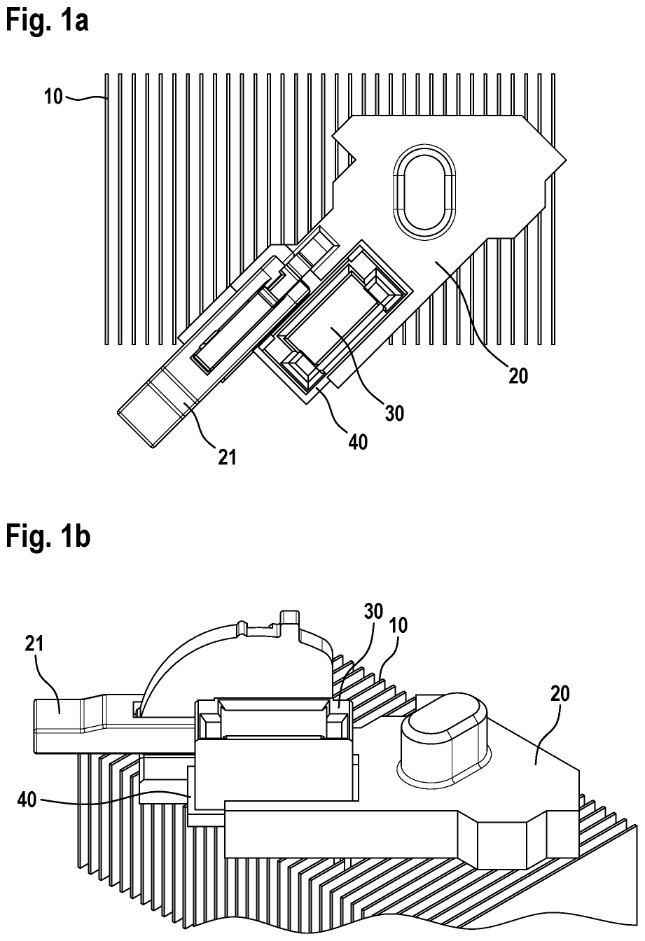

Relevant sections of a fuel cell according to an embodiment of the invention are shown in FIGS. 1a to 1c. The fuel cell has a plurality of contacting surfaces on bipolar plates 10. A voltage tapping device 20 is arranged on the contacting surfaces of the parallel bipolar plates 10. The voltage tapping device 20 includes a housing with a latching lever 21, which serves to align and fix the printed circuit board 40 in a suitable position in the housing. A voltage tapping device 20 is understood here to be a device with which electrical voltages can be tapped at several bipolar plates 10 and which can be mechanically connected to the bipolar plates 10 via the plastic housing, for example, but can also be separated from them.

A comb-like arrangement and a plurality of fastening elements 22 on an underside of the voltage tapping device 20, shown in FIG. 1c, serving as positioning aids, which are arranged in two parallel rows, engage between the bipolar plates 10 in a manner of ribs and secure alignment of the voltage tapping device 20 on the bipolar plates 10. To ensure that no short circuit is generated between the bipolar plates 10 by the voltage tapping device 20, the arrangement and/or fastening elements 22 are designed to be electrically insulating.

An electrical connector 30, such as a plug connector, whose mating face points upwards, connects the printed circuit board 40 to a measuring device. The printed circuit board 40 is mechanically and electrically connected to the plug connector 30. A mechanically detachable electrical connection to the measuring device can be established via this interface, with the help of which the tapped cell voltages can be evaluated.

A pair of conductive rubber elements 50a, 50b (a first conductive rubber element 50a and a second conductive rubber element 50b) are arranged on the underside of the printed circuit board 40, which faces the bipolar plates 10. The conductive rubber elements 50a, 50b are each positioned at an angle of 45° to the bipolar plates 10.

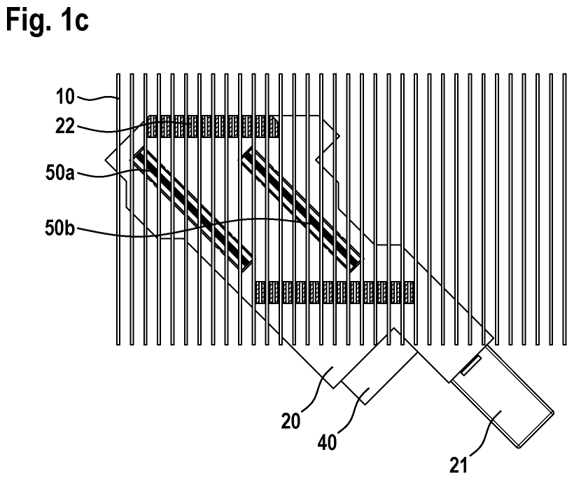

FIG. 2 shows the fuel cell with the voltage tapping device 20 positioned on the bipolar plates 10, in which the second conductive rubber element 50b has been removed for better understanding. As shown in FIG. 2, the removed conductive rubber element 50b contacts the printed circuit board 40 on its side facing away from the bipolar plates 10. The printed circuit board 40 comprises an electrical circuit board contact element 41 above each bipolar plate 10 or each electrical tapping point that is contacted by the conductive rubber element 50b. In this embodiment, eight circuit board contact elements 41 are arranged in a row on the printed circuit board 40. The number of circuit board elements 41 can differ in other embodiments.

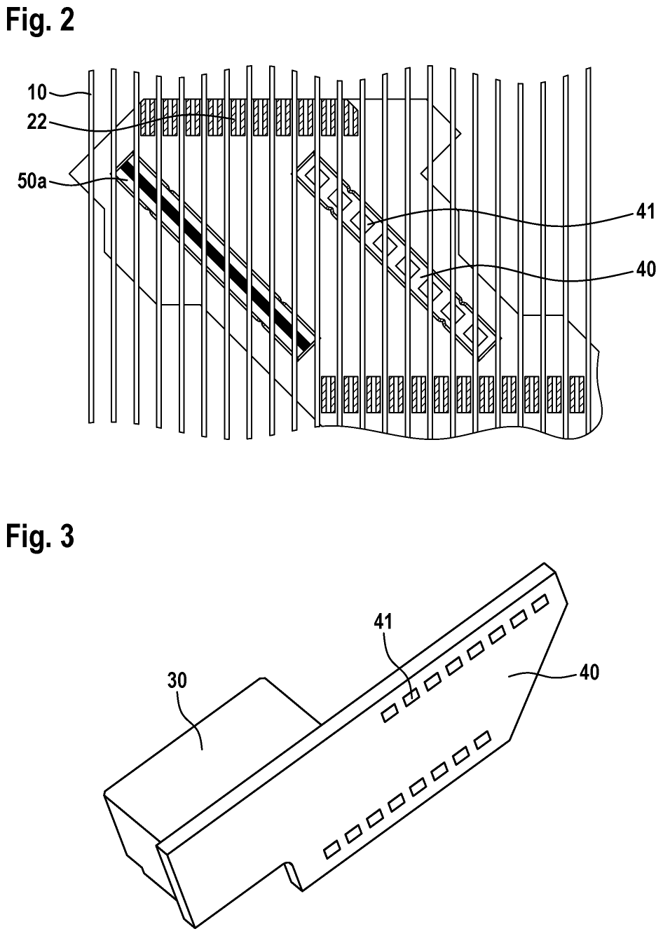

FIG. 3 shows an underside of the printed circuit board 40. In addition to the row of eight circuit board contact elements 41, which are provided to contact the second conductive rubber element 50b, there is a further row of circuit board contact elements 41, which is provided to contact the first conductive rubber element 50a. This row also comprises eight circuit board contact elements 41. Each of the two conductive rubber elements 50a, 50b thus establishes an electrical connection between the eight contacting surfaces on bipolar plates 10 and the associated contact elements 41 of the printed circuit board 40, so that the electrical voltage can be tapped at sixteen bipolar plates 10 via a routing on the printed circuit board and the plug connector 30, which represents a relevant input signal for the control of a fuel cell.

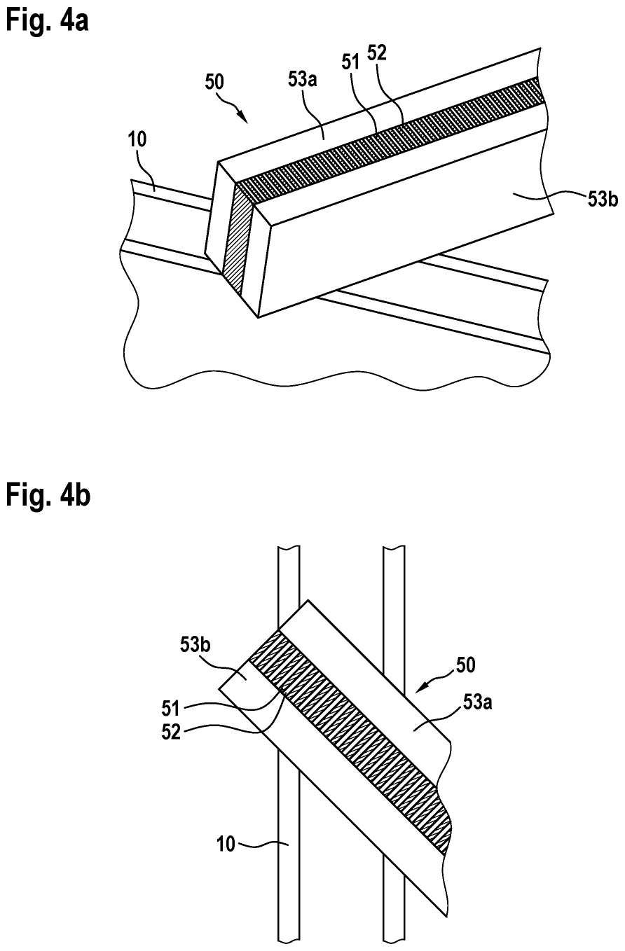

In one embodiment of the invention, FIGS. 4a and 4b show the contact between a conductive rubber element 50 and two bipolar plates 10 arranged at the edge of a fuel cell.

The conductive rubber element 50 comprises a central area consisting alternately of electrically conductive regions 51 and electrically insulating regions 52. Such a conductive rubber element 50a, 50b is also referred to as zebra rubber. These regions 51, 52 are sandwiched between electrically insulating edge layers 53a, 53b. All parts 51, 52, 53a, 53b of the conductive rubber element 50 are made of a silicone rubber.

Electrically conductive regions 51 are understood to mean areas with a maximum electrical resistance of 105 Ohm/cm. Electrically insulating regions 52 are understood to mean areas with an electrical resistance of more than 109 Ohm/cm. The electrically conductive regions 51 and the electrically insulating regions 52 comprise in particular the same dimensions along the longitudinal axis of the conductive rubber element 50. The geometric sum of the conductive and non-conductive layers (also called grid) is smaller than the width of a bipolar plate 10. The grid of the conductive rubber element, in an embodiment, is in the range of 0.05 mm to 1.00 mm. If the grid of the conductive rubber element 50 and its core width are selected to match the grid or spacing of the bipolar plates 10 in a stack, a short circuit between two adjacent bipolar plates can be prevented, even if the stack is shortened or lengthened over its life cycle.

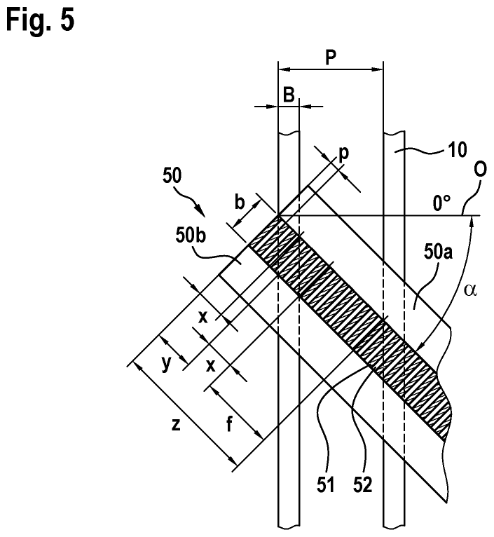

The conductive rubber element 50 is arranged at an angle α to an orthogonal to the bipolar plates 10, as shown in FIG. 5, which satisfies the condition according to formula 1:

$$B \geq 3.5 \cdot p \cdot cos ( α ) - b \cdot sin ( α ) \qquad ( Formula 1 )$$

Here, p is a grid of the conductive rubber element 50, B is a width of a contacting surface on the bipolar plates 10 and b is a width of the conductive rubber element 50. This defines a minimum value for the angle α, so that a better overlap is achieved between the conductive regions 51 of the conductive rubber element 50 and the bipolar plates 10, than if the conductive rubber element 50 were arranged orthogonally (α=0) to the bipolar plates 10. This increases the robustness of the electrical contacting against vibration and shock loads even if the bipolar plates 10 in the fuel cell change geometrically over their life cycle.

In an embodiment, the condition according to formula 2 is satisfied:

$$α \leq sin - 1 ( ( P - 2 - B ) / ( 2 b ) ) \qquad ( Formula 2 )$$

Here, P is the distance between two adjacent contacting surfaces on bipolar plates 10.

This defines a maximum value for the angle α. This creates a practical compromise between good electrical contact between conductive rubber element 50 and bipolar plates 10 and a sufficient number of non-electrically contacted conductive layers 51, which is relevant for air and creepage distance protection (avoidance of short circuits).

In an embodiment, the two electrically insulating edge layers 53a, 53b are made in one piece with the conductive rubber element 50 and consist of the same material as the electrically insulating regions 52 of the conductive rubber element 50. In this embodiment of the fuel cell, however, the width b of the conductive rubber element 50 according to formulas 1 and 2 is still understood to be only the width of the electrically conductive 51 and electrically insulating 52 regions and not the overall width of the conductive rubber element 50 increased by the two edge layers 53a, 53b.

In order to ensure constant elasticity of the conductive rubber element 50 in all its regions, the electrically conductive regions 51, the electrically insulating regions 52 and any electrically insulating edge layers 53a, 53b are made of the same plastic material. The plastic material is electrically insulating in its unmodified state, whereby the electrically conductive regions 51 of the plastic material may be given an electrically conductive finish, for example by adding carbon, such as graphite, silver, or gold.

In FIG. 5, the geometric dimensions and angles of the contacting surfaces on the bipolar plates 10 and the conductive rubber element 50 are shown in an embodiment of the invention. The bipolar plates 10 each have a width B of 0.2 mm. A distance P between two consecutive contacting surfaces on bipolar plates 10 is 1.0 mm. The distance P is the distance between the left edge of the contacting surface of one bipolar plate 10 and the left edge of the next contacting surface.

The electrically conductive regions 51 and electrically insulating regions 52 of the conductive rubber element 50 each have a width b of 0.4 mm. The electrically insulating edge layers 53a, 53b each have the same width of 0.4 mm. A grid pitch p of the conductive rubber element can be 0.1 mm. The grid pitch is understood to be the distance from the beginning of one electrically conductive region 51 to the beginning of the next electrically conductive region 51.

An overlap between the electrically conductive regions 51 and electrically insulating regions 52 of the conductive rubber element 50 and a bipolar plate 10 correspond to the width B of the bipolar plates 10 if the conductive rubber element 50 is arranged orthogonally to the bipolar plates 10. If, however, the conductive rubber element 50 is arranged at an angle α shown in FIG. 5, which in the present embodiment is 45°, relative to the orthogonal O, the overlap x is calculated according to formula 3:

$$x = \frac{B}{cos ( α )} \qquad ( Formula 3 )$$

A distance y, shown in FIG. 5, by which the conductive rubber element 50 partially protrudes beyond a bipolar plate 10 is calculated according to formula 4:

$$y = b \cdot tan ( α ) \qquad ( Formula 4 )$$

It provides an additional contacting surface between bipolar plate 10 and conductive rubber element 50, which increases the electrical contact area between bipolar plate 10 and conductive rubber element 50 compared to an orthogonal arrangement. It increases with increasing angle α and with increasing width b of the electrically conductive regions 51 and electrically insulating regions 52 of the conductive rubber element 50.

The distance from a left edge of a bipolar plate 10 to the left edge of the next bipolar plate 10, which is covered by the conductive rubber element 50, corresponds to the distance P of the bipolar plates 10 in an orthogonal arrangement of the conductive rubber element 50. With an increasing angle α, this distance z comprises an increasing value according to formula 5:

$$z = \frac{P}{cos ( α )} \qquad ( Formula 5 )$$

The distances x and y in relation to the grid p of the conductive rubber element 50 should satisfy the condition of formula 6:

$$x + y \geq 3.5 \cdot p \qquad ( Formula 6 )$$

Inserting formulas 3 and 4 into formula 6 results in formula 1.

In order to limit the maximum value of the angle α, the conditions of formulas 7 and 8 should be satisfied:

$$x + y \leq f \qquad ( Formula 7 )$$

$$f = z - x - y \qquad ( Formula 8 )$$

The distance z should therefore consist of a maximum of half the sum of the distances x and y. To describe this, the distance f is also introduced, which denotes the difference between the distance z and the distances x and y. Inserting formulas 3 to 5 into formulas 7 and 8 results in formula 2.

By using an angle α of more than 0°, a longer distance is covered with the conductive rubber element 50 perpendicular to the stacking direction of the bipolar plates 10 than would be the case with an orthogonal arrangement between conductive rubber element 50 and bipolar plates 10. In order to be able to provide a compact voltage tapping device on the fuel cell, several individual conductive rubber elements 50 are arranged on the fuel cell, which are arranged orthogonally to their respective longitudinal axes and offset from one another. In an embodiment, the fuel cell comprises two conductive rubber elements 50. For this purpose, a plastic housing can be provided, which is positioned on the fuel cell and has recesses to accommodate two conductive rubber elements 50. In an embodiment, each individual conductive rubber element 50 contacts 6 to 10 contacting surfaces on bipolar plates 10. In this embodiment of the fuel cell, the circuit board 40 comprises several rows of electrical circuit board contact elements 41 on its underside, each of which is arranged at specific points above one of the conductive rubber elements 50.

In another embodiment, the present disclosure relates to the voltage tapping device 20 arranged on a fuel cell according to the first aspect. Such a voltage tapping device 20 can be subsequently attached to a conventional fuel cell in order to electrically contact its bipolar plates 10 and thus obtain a fuel cell according to the embodiment described above, which can be suitably monitored and controlled. For maintenance and repair purposes, the entire voltage tapping device 20 can also be disconnected from the fuel cell.

1. A fuel cell, comprising:
a plurality of bipolar plates having a plurality of contacting surfaces; and
a conductive rubber element having a plurality of electrically conductive regions alternating successively with a plurality of electrically insulating regions, the conductive rubber element is arranged at an angle α to an orthogonal of the contacting surfaces of the bipolar plates, wherein:
$$B \geq 3.5 \cdot p \cdot cos ( α ) - b \cdot sin ( α )$$
is satisfied, wherein B is a width of one of the contacting surfaces on one of the bipolar plates, b is a width of the electrically conductive regions and electrically insulating regions of the conductive rubber element, and p is a grid pitch of the conductive rubber element.

2. The fuel cell of claim 1, wherein a condition:
$$α \leq sin - 1 ( ( P - 2 - B ) / ( 2 b ) )$$
is satisfied, wherein P is a distance between a pair of adjacent contacting surfaces of the plurality of contacting surfaces.

3. The fuel cell of claim 1, wherein the electrically conductive regions and the electrically insulating regions are arranged between a pair of electrically insulating edge layers.

4. The fuel cell of claim 3, wherein the electrically conductive regions, the electrically insulating regions, and the electrically insulating edge layers are made of a silicone rubber.

5. The fuel cell of claim 4, wherein the electrically conductive regions are made conductive by the addition of a carbon or a metal material.

6. The fuel cell of claim 1, further comprising a printed circuit board with a plurality of electrical circuit board contact elements.

7. The fuel cell of claim 6, wherein the electrical circuit board contact elements are arranged on a side of the conductive rubber element facing away from the contacting surfaces of the bipolar plates.

8. The fuel cell of claim 7, wherein each of the electrical circuit board contact elements is arranged above one of the contacting surfaces of one of the bipolar plates that is contacted by the conductive rubber element.

9. The fuel cell of claim 6, wherein the printed circuit board and the conductive rubber elements are part of a voltage tapping device.

10. The fuel cell of claim 9, wherein the voltage tapping device has a plurality of arrangement and/or fastening elements arranged parallel to a stacking direction of the bipolar plates.

11. The fuel cell of claim 10, wherein the arrangement and/or fastening elements engage between the bipolar plates.

12. The fuel cell of claim 6, wherein the printed circuit board is mechanically and electrically connected to an electrical plug connector.

13. The fuel cell of claim 1, wherein the conductive rubber element is one of a plurality of conductive rubber elements arranged offset from one another orthogonally to a plurality of longitudinal axes of the conductive rubber elements.

14. A voltage tapping device, comprising:
a conductive rubber element having a plurality of electrically conductive regions alternating successively with a plurality of electrically insulating regions, the conductive rubber element is arranged at an angle α to an orthogonal of a plurality of contacting surfaces of a plurality of bipolar plates, wherein:
$$B \geq 3.5 \cdot p \cdot cos ( α ) - b \cdot sin ( α )$$
is satisfied, wherein B is a width of one of the contacting surfaces on one of the bipolar plates, b is a width of the electrically conductive regions and electrically insulating regions of the conductive rubber element, and p is a grid pitch of the conductive rubber element.

15. The voltage tapping device of claim 14, further comprising a printed circuit board with a plurality of electrical circuit board contact elements.

16. The voltage tapping device of claim 15, wherein the electrical circuit board contact elements are arranged on a side of the conductive rubber element facing away from the contacting surfaces of the bipolar plates.

17. The voltage tapping device of claim 16, further comprising has a plurality of arrangement and/or fastening elements arranged parallel to a stacking direction of the bipolar plates.

18. The voltage tapping device of claim 17, wherein the arrangement and/or fastening elements engage between the bipolar plates to detachably arrange the voltage tapping device on a fuel cell having the bipolar plates.
